(19) United States
(12) Patent Application Publication
(10) Pub. No.: US 2023/0146257 A1
(43) Pub. Date: May 11, 2023

(54) NEEDLE STROKE SWITCH AND FUEL INJECTOR HAVING SUCH A NEEDLE STROKE SWITCH

(71) Applicant: LIEBHERR-COMPONENTS DEGGENDORF GMBH, Deggendorf (DE)

(72) Inventors: Norbert SCHOEFBAENKER, Ohlsdorf (AT); Richard PIRKL, Regensburg (DE); Klaus WERANECK, Lalling (DE); Carina RAUSCHER, Strasskirchen (DE)

(21) Appl. No.: 17/907,524

(22) PCT Filed: Mar. 25, 2021
(86) PCT No.: PCT/EP2021/057776

§ 371 Date: Sep. 27, 2022

(30) Foreign Application Priority Data
Mar. 30, 2020 (DE) 10 2020 108 668.7

(51) Int. Cl. F02M 47/02; F02M 65/00; F02M 51/06; F02M 61/16; F02M 61/18

(52) U.S. Cl. CPC F02M 47/027; F02M 65/005; F02M 51/0671; F02M 61/166; F02M 61/1886; F02M 2200/9007; F02M 61/168

(57) ABSTRACT

A needle stroke switch and a fuel injector having such a switch, the needle stroke switch including a seat plate having a plate-like main body and a passage connecting the two planar sides of the plate-like main body, an anchor element which can be lifted off from the passage in the seat plate, and a control valve which is arranged on the side of the seat plate opposite the anchor element and is designed to interact with a nozzle needle. The seat plate is electrically isolated from a surrounding injector housing and an electrical connection to the injector housing is possible only via the nozzle needle which interacts with the seat plate. Furthermore, the needle stroke switch is characterised in that at least one ceramic and/or plastic part is provided which contacts the seat plate in order to isolate the seat plate from the surrounding injector housing.

### TECHNICAL FIELD

The present invention relates to a needle stroke switch and to a fuel injector having such a needle stroke switch.

### BACKGROUND AND SUMMARY

In internal combustion engines such as diesel engines or gasoline engines, fuel is as a rule injected via an injector into a combustion chamber in a specific quantity and for a specific time period. It is necessary in this process, due to the very small injection times that are in the microsecond range, to open or close the discharge opening of the injector at a very high frequency. It is necessary to provide an injection state detection for an exact control of these closing times and for an exact detection of an injector state so that a higher ranking control unit receives all of the information of an individual injector, in particular information with respect to its closing or opening times.

An injector typically has a nozzle needle (also: injector needle) that allows a highly compressed fuel to exit outwardly on release of a discharge hole of the injector. This nozzle needle acts in cooperation with this discharge opening as a plug that enables a discharge of the fuel when raised. It is therefore accordingly necessary to raise this needle at relatively short time intervals and to allow it to slide back into the discharge opening again after a brief period. In this respect, hydraulic servo valves can be used that control the triggering of this movement. Such valves are in turn controlled with the aid of an electromagnet. Alternatively to this, a piezo element can be used that responds faster than the valve controlled by means of electromagnets.

Due to the high injection pressures of more than 2500 bar, it is not possible to control or to move the nozzle needle directly with the aid of a magnetic valve. The required forces for opening and closing the nozzle needle would be too great here so that such a process would only be able to be implemented with the aid of very large electromagnets. Such a design is, however, excluded due to the limited available installation space in an engine.

So-called servo valves that control the nozzle needle and are themselves controlled via an electromagnetic valve or a piezo valve are typically used instead of direct control. In this respect, a pressure level that acts on the nozzle needle in the closure direction is built up in a control space cooperating with the nozzle needle with the aid of the available highly compressed fuel. This control space or control valve is typically connected to the high pressure region of the fuel via a feed throttle. This control space furthermore has a small closable outflow throttle from which the fuel can escape to a low pressure region. If the fuel escapes, the pressure in the control space and the closure force acting on the nozzle needle are reduced since the highly compressed fuel of the control space can flow off. A movement of the nozzle needle is thereby produced that releases the discharge opening at the injector tip. To be able to control the movement of the nozzle needle, the outflow throttle of the valve is therefore selectively closed or opened with the aid of an armature element.

Since the general principle of an injector for injecting fuel is familiar to the skilled person, the functionality of this component will not be looked at in a more in-depth manner in the following.

As already briefly outlined above, the injector state detection is of great importance for a regulated operation of the injector. With previous injectors, it is not necessary or is very complex and/or expensive to provide a seat plate of the injector that is electrically separate from the injector casing and conducts current at certain points so that the control valve arranged thereunder and the nozzle needle are connected to the injector coil arranged thereabove. The ability to conduct an electric signal through the seat plate is, however, of advantage with respect to a state recognition since an electric circuit can thus be generated with a closed injector via the contact of the nozzle needle in the nozzle needle seat of the injector. The requirement for this is of course that this electric circuit is not already closed at another point so that the seat plate inter alia has to be electrically insulated with respect to the injector casing. The closing of the electric circuit may only take place via the nozzle needle and the nozzle needle seat.

The seat plate of the injector is accordingly a component that is used in accordance with the invention both as a contact element for conducting through an electric signal and simultaneously has to be insulated with respect to the injector casing. The seat plate furthermore includes a passage that runs from the top to the bottom and that represents the outflow throttle of an injector. By placing the seat plate on an armature element and sealing the passage, the control space disposed thereunder fills via an inflow with highly compressed fuel so that the nozzle needle is urged into its closure position. On a raising of the armature element from a passage opening, the fuel stored at high pressure flows off and reduces the force influence acting on the nozzle needle so that it rises from its discharge openings and fuel can flow out.

The more detailed function of an injector is shown, for example, in DE 10 2017 116 383.2.

It has previously been known to implement an insulation of the seat plate by means of a DLC layer (DLC stands for “diamond-like carbon” here), but with it having been shown that the robustness of such a DLC layer is not sufficient for demanding injector concepts. An improved robustness of the insulating layer is in particular required when the seat plate is axially preloaded by means of a screw.

Long-term tests have thus shown that these layers have the tendency to become electrically conductive under a mechanical load. This is due to their mechanical wear so that no continuous electrical insulation can be ensured over the typical service life of an injector.

It is therefore the object of the present invention to provide a needle stroke switch that overcomes the stated disadvantage and can also be used in challenging injector concepts.

This is done using a needle stroke switch for an injector as described in further detail below.

Provision is made in accordance with the invention that the needle stroke switch for a fuel injector comprises a seat plate having a plate-like base body and a passage connecting the two areal sides of the plate-like base body, an armature element that can be raised from the passage of the seat plate and can be sealingly placed thereon, and a control valve that is arranged at the side of the seat plate oppositely disposed the armature element and that is configured to cooperate with a nozzle needle, wherein the seat plate is electrically insulated with respect to an injector casing surrounding it and an electrical connection with the injector casing can only be implemented via the nozzle needle cooperating with the seat plate. The needle stroke switch is further characterized in that at least one ceramic and/or plastic part contacting the seat plate is present to generate the insulation of the seat plate with respect to the injector casing surrounding it.

Provision can furthermore be made in accordance with the invention that the at least one ceramic and/or plastic part is an all-ceramic part. Ceramic material is thus in particular of stable shape at a high and also pulsating pressure load and displays an exceptional wear resistance.

The at least one ceramic and/or plastic part can furthermore be designed releasably with the seat plate in accordance with the invention. It is accordingly clear that the ceramic and/or plastic part does not only represent a coating of the seat plate, but is a part separate from the seat plate.

Provision can be made in accordance with an optional modification of the invention that the nozzle needle base body is composed of an electrically conductive material, for example a metal, and the plastic and/or ceramic sleeve is preferably composed of an electrical insulator that, for example, comprises the components Al₂O₃, Zr₂O₃ and/or Si₃Ni₃ or consists of at least one of these components.

Zirconia is in particular advantageous in use here since it has a very similar coefficient of thermal expansion to steel and is thereby also very suitable for interference fit assemblies. Interference fit assemblies can also be implemented for applications having high temperature fluctuations (for example with injection nozzles) due to the approximately same coefficient of thermal expansion. Zirconia is very tough in comparison with other ceramic materials and can therefore in particular advantageously be used in abrupt or pulsating loads such as occur due to compression waves in the injector. Zirconia has considerable advantages tribologically in comparison with aluminum oxide because it causes hardly any wear at the contact partners.

Provision can furthermore be made in accordance with the invention that the at least one ceramic and/or plastic part has a sleeve form, in particular an annular form or a cylinder jacket form that is suitable for the radial surrounding of the seat plate, with the seat plate preferably being inserted into the sleeve-like ceramic and/or plastic part to achieve a radial centering of the seat plate and to form an electrical insulation between the seat plate and the injector casing.

This sleeve-like ceramic and/or plastic part substantially serves to protect the live seat plate from a direct electrical contact with the injector casing surrounding the seat plate. A contact with the injector casing should take place exclusively via the nozzle needle and the nozzle needle seat receiving the nozzle needle in the closed state of the injector to simply detect whether the injector is open or closed.

Provision can be made here that the sleeve-like ceramic and/or plastic part for the radial surrounding of the seat plate is fixedly connected to the injector casing, preferably by a connection having material continuity or a form fit.

Provision can be made in accordance with a further development of the invention that the at least one ceramic and/or plastic part is a seat part that cooperates with the armature element and can be sealingly placed on the passage of the seat plate, with the seat part preferably having a cylindrical shape.

In this respect, the seat part can have rounded corners for placing on the passage of the seat plate to avoid the edges escaping, with the slide grinding method preferably being used to produce the rounded corners. The provision of rounded corners is advantageous since an escaping of the edges can thus be avoided in operation.

The seat part can here furthermore be a ceramic part that is preferably manufactured by hot isostatic pressing. Ceramic material additionally then also displays exceptional wear resistance if small solid body particles area contained in the fuel that produce an abrasive effect when flowing along the seat part. Fuel flows out of the passage and in so doing comes into contact with the seat part, in particular when the injector injects fuel and the seat part is raised from the passage of the seat plate.

Provision can furthermore be made in accordance with the invention that the seat part electrically insulates the seat plate toward the armature element and toward an armature guide of the armature element.

A further advantageous development of the invention provides that the at least one ceramic and/or plastic part is a seat plate support that is arranged on the areal side of the plate-like base body of the seat plate facing the armature element and electrically insulates the seat plate from an armature guide of the armature element or the injector casing.

Provision can be made here that the seat plate support lies on the areal side of the plate-like base body of the seat plate facing the armature element and preferably has an annular form.

A conductive contact from the armature guide on the seat plate is prevented by the seat plate support so that it is electrically insulated with respect thereto.

The invention further relates to a fuel injector having a needle stroke switch in accordance with one of the preceding variants.

Provision can be made here that the fuel injector has an injector state recognition that recognizes an injector state of a closed injector with reference to a current flowing through the nozzle needle and the injector casing.

An engine having a fuel injector in accordance with one of the preceding variants is furthermore covered by the invention.

### BRIEF DESCRIPTION OF THE FIGURES

Further advantages, features, and details of the present invention will become clear on the basis of the following description of the Figures. There are shown:

FIG. 1: a schematic representation to explain the already known prior art;

FIG. 2: a schematic representation of the device in accordance with the invention, and

FIG. 3: a schematic representation of an embodiment in accordance with the invention of the present invention.

### DETAILED DESCRIPTION

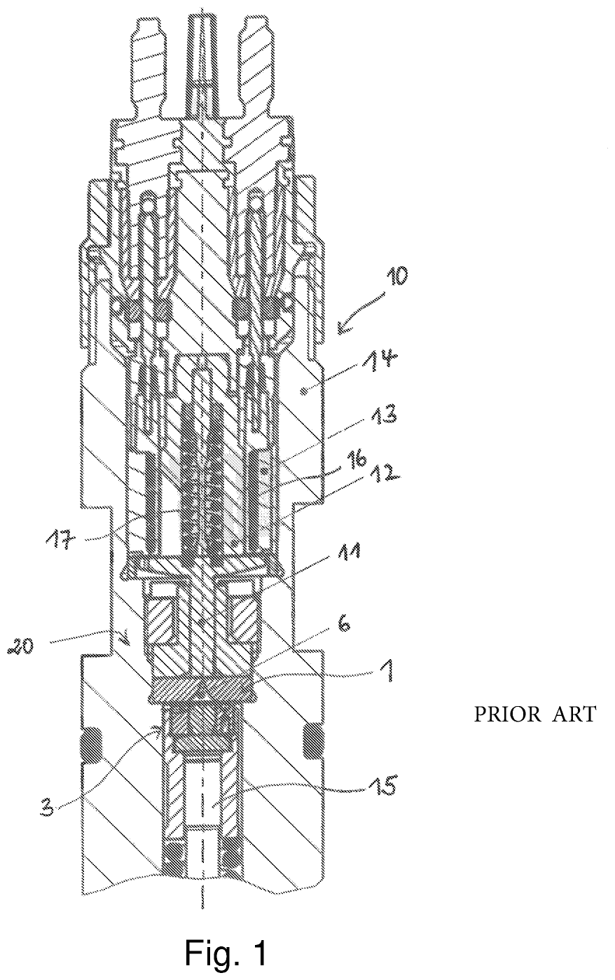

FIG. 1 shows a partial sectional view of an injector 10 from the prior art. The injector 10 can be recognized as having a casing 14 in which a plurality of injector components are arranged. The injector needle 15, the valve formed by the armature 11, the seat plate 1, and the electromagnet 12, 13 that has a coil winding 16, an inner magnetic pole 12, and an outer magnetic pole 13 are essential to the function of the injector 10. A cutout for arranging the spring 17 that urges the armature element 11 in the direction of the valve is furthermore provided in the inner magnetic pole 12 to close the outflow throttle of the valve in a currentless state of the electric magnet 12, 13 in a fluid tight manner.

If the electromagnet 12, 13 is activated, it pulls the armature element 11 away from the valve with the aid of magnetic force so that highly compressed fuel can flow out of the passage 6 from a control space closable by the valve. Since the pressure in the control space that acts on the injector needle is hereby reduced, the latter can slide out of a closed position and enables the dispensing of fuel from the injector 10. If, in contrast, the electromagnet 12, 13, is moved into a currentless state, the magnetic force acting on the armature element 11 is reduced so that the spring element 17 urges the armature element 11 onto the discharge opening of the valve and seals the control space or the passage 6. The pressure acting on the injector needle 15 thereby increased, whereby the latter is again urged into its closed position. There is accordingly no longer any outflow of fuel from the discharge opening of the injector 10.

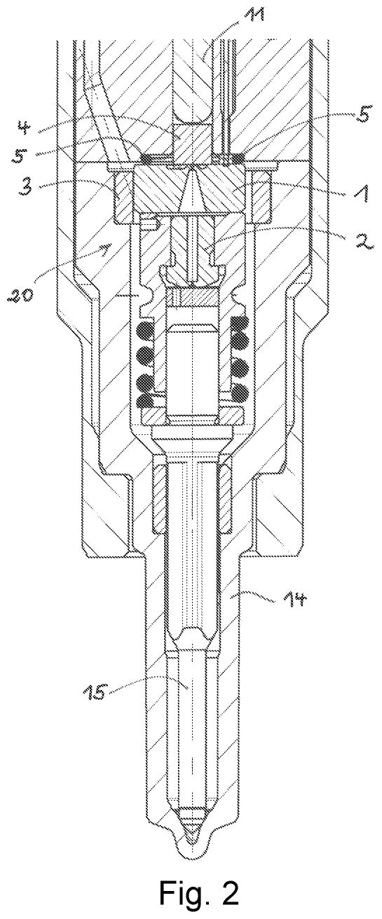

FIG. 2 shows a sectional view of an injector 10 having a needle stroke switch 20 in accordance with the invention.

To insulate the seat plate 1, a plurality of parts comprising ceramics and/or plastic are provided of which each is in contact with the seat plate 1.

To project the peripheral marginal surface of the approximately plate-like seat plate 1 from an electrically conductive contact with the injector casing, a sleeve-like ceramic and/or plastic part 3 is provided that surrounds the seat plate in a radial peripheral direction. The sleeve 3 can here be fixedly connected, in particular adhesively bonded or soldered, to the injector casing. The sleeve 3 serves the radial centering of the seat plate 1 in addition to the electrical insulation.

A seat part 4 be recognized beside in FIG. 2 that preferably comprises a ceramic material (for example Al₂O₃ or Si₂Ni₃) and cooperates with the armature element 11 such that it can close the passage 6 of the seat plate. If the armature element 11 is attracted by the seat plate 1, the passage 6 of the seat plate 1 also opens and there is an outflow of highly compressed fuel so that the pressure in the control space drops and there is a rising of the nozzle needle 15 from its nozzle needle seat.

To achieve an electrical insulation of the seat plate with respect to the armature element 11 that is as a rule placed onto the passage 6 of the seat plate 1, an insulating seat part 4 is now provided between the armature element 11 and the seat plate. This, as a rule, cylindrical element can have rounded edges and has to be inspected for freedom from cracks caused by the dynamically bearing load. It is furthermore of advantage if it is manufactured by hot isostatic pressing.

It is of particular advantage for the seat part if it is produced from ceramic material since ceramic material has excellent wear resistance and is in particular also durable with respect to the abrasive effect of solid particles present in the fuel. Fuel thus flows at high speed at the lower side of the seat part 4 if the injector is in its open position.

The seat part 4 insulates the seat plate 1 electrically with respect to the armature element 11 and the armature guide or the injector casing.

A seat plate support 5 that separates the seat plate 1 at its side facing the armature element 11 from the armature guide or the injector casing 14 is shown as a further ceramic and/or plastic part.

It also applies here due to the pulsating compressive strain that the seat plate support is advantageously of ceramic material. Ceramic material also remains in a stable shape under a high pressure load so that deformation changing the armature stroke setting cannot occur.

The seat plate support 5 is advantageously in a ring that has an inner diameter that is larger than the outer diameter of the seat part 4. Finally, both ceramic and/or plastic parts 4, 5 contact the areal side of the seat plate 1 facing the armature element 11.

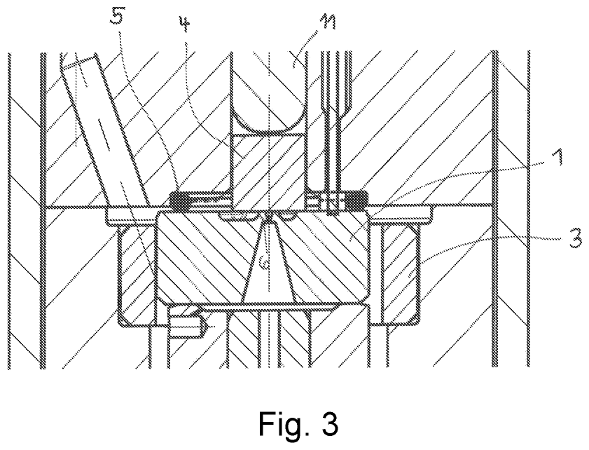

FIG. 3 is a magnified representation of FIG. 2 from which the ceramic and/or plastic parts can be particularly easily recognized.

1. A needle stroke switch for a fuel injector comprising:
a seat plate having a plate-like base body and a passage connecting the two areal sides of the plate-like base body;
an armature element that can be raised from the passage of the seat plate and can be sealingly placed thereon; and
a control valve that is arranged at a side of the seat plate oppositely disposed the armature element and that is adapted to cooperate with a nozzle needle, wherein
the seat plate is electrically insulated with respect to an injector casing surrounding it; and wherein an electrical connection to the injector casing can only be implemented via the nozzle needle cooperating with the seat plate,
comprising
at least one ceramic and/or plastic part contacting the seat plate to insulate the seat plate with respect to the injector casing surrounding the seat plate.

2. The needle stroke switch in accordance with claim 1, wherein the at least one ceramic and/or plastic part is an all-ceramic part.

3. The needle stroke switch in accordance with claim 1, wherein the at least one ceramic and/or plastic part is designed releasably with the seat plate.

4. The needle stroke switch in accordance with claim 1, wherein the at least one ceramic and/or plastic part comprises the components Al₂O₃, Si₃Ni₃ and/or Zr₂O₃ or consists of at least one of these components.

5. The needle stroke switch in accordance with claim 1, wherein the at least one ceramic and/or plastic part has a cylinder jacket shape that is suitable to radially surround the seat plate.

6. The needle stroke switch in accordance with claim 5, wherein the ceramic and/or plastic part for the radial surrounding of the seat plate is fixedly connected to the injector casing.

7. The needle stroke switch in accordance with claim 1, wherein the at least one ceramic and/or plastic part is a seat part that interacts with the armature element and can be sealingly placed on the passage of the seat plate.

8. The needle stroke switch in accordance with claim 7, wherein the seat part has rounded corners for placing on the passage of the seat plate to avoid edges of the seat plate escaping.

9. The needle stroke switch in accordance with claim 7, wherein the seat part is a ceramic part.

10. The needle stroke switch in accordance with claim 7, wherein the seat part electrically insulates the seat plate toward the armature element and toward an armature guide of the armature element.

11. The needle stroke switch in accordance with claim 1, wherein the at least one ceramic and/or plastic part is a seat plate support that is arranged on the areal side of the plate-like base body of the seat plate facing the armature element and electrically insulates the seat plate from an armature guide of the armature element or the injector casing.

12. The needle stroke switch in accordance with claim 11, wherein the seat plate support lies on the areal side of the plate-like base body of the seat plate facing the armature element.

13. A fuel injector having the needle stroke switch in accordance with claim 1.

14. The fuel injector in accordance with claim 13, wherein the fuel injector has an injector state recognition that recognizes an injector state of a closed injector with reference to a current flowing through the nozzle needle and the injector casing.

15. An engine having a fuel injector in accordance with claim 13.

16. The needle stroke switch in accordance with claim 5, wherein the at least one ceramic and/or plastic part has an annular form or a cylinder jacket shape.

17. The needle stroke switch in accordance with claim 5, wherein the seat plate can be inserted into the ceramic and/or plastic part to achieve a radial centration of the seat plate and to form an electrical insulation between the seat plate and the injector casing.

18. The needle stroke switch in accordance with claim 6, wherein the ceramic and/or plastic part of the radial surrounding of the seat plate is fixedly connected to the injector casing by a connection having material continuity or a form fit, wherein the connection is adhesive bonding or soldering.
